(19) United States
(12) Patent Application Publication
(10) Pub. No.: US 2023/0211792 A1
(43) Pub. Date: Jul. 6, 2023

(54) REVERSE DIRECTION TRAVELING DETECTION APPARATUS AND REVERSE DIRECTION TRAVELING DETECTION METHOD

(71) Applicant: Honda Motor Co., Ltd, Tokyo (JP)

(72) Inventors: Yasuo Oishi, Tokyo (JP); Akira Iihoshi, Tokyo (JP); Atsuki Kakinuma, Tokyo (JP); Takeo Tokunaga, Tokyo (JP); Hiroyuki Onimaru, Tokyo (JP)

(21) Appl. No.: 17/923,911

(22) PCT Filed: Apr. 28, 2021
(86) PCT No.: PCT/JP2021/016983

§ 371 Date: Nov. 7, 2022

(30) Foreign Application Priority Data
May 12, 2020 (JP) 2020-083544

(51) Int. Cl. B60W 40/10; B60W 40/06; B60W 50/14

(52) U.S. Cl. CPC B60W 40/10; B60W 40/06; B60W 50/14; B60W 2556/45; B60W 2552/20; B60W 2050/143; B60W 2520/06

(57) ABSTRACT

A reverse direction traveling detection apparatus including a microprocessor. The microprocessor is configured to perform acquiring an actually measured road surface profile of a road surface on which a vehicle is traveling, determining a travel direction of the vehicle based on position information of the vehicle, further determining whether a coincidence degree between the actually measured road surface profile and a first reference road surface profile in a first lane is equal to or greater than a predetermined value when it is determined that the travel direction of the vehicle is a first direction, and determining whether the vehicle travels in reverse direction based on the actually measured road surface profile and a second reference road surface profile in a second lane when it is determined that the coincidence degree is less than the predetermined value.

### CROSS-REFERENCE TO RELATED APPLICATION

This application is a National Stage of PCT international application Ser. No. PCT/JP2021/016983 filed on Apr. 28, 2021 which designates the United States, incorporated herein by reference, and which is based upon and claims the benefit of priority from Japanese Patent Application No. 2020-083544, filed on May 12, 2020, the entire contents of which are incorporated herein by reference.

### TECHNICAL FIELD

This invention relates to a reverse direction traveling detection apparatus and reverse direction traveling detection method that detects traveling in a reverse direction of a vehicle.

### BACKGROUND ART

Conventionally, as an apparatus of this type, there is known an apparatus that captures an image of a vehicle at a predetermined frame cycle by a camera installed on a road, thereby detecting a traveling in a reverse direction of the vehicle (see, for example, Patent Literature 1). The apparatus described in Patent Literature 1 compares the position information of the license plate in the current frame captured by the camera with the position information of the license plate one frame ago, and determines the travel in the reverse direction of the vehicle based on the moving direction of the license plate.

### CITATION LIST

### Patent Literature

Patent Literature 1: Japanese Unexamined Patent Publication No. 2004-234486

### DISCLOSURE OF INVENTION

### Problems to be Solved by the Invention

However, the device described in the above Patent Literature 1 requires a large number of cameras overall when detecting the travel in the reverse direction on many roads, which can easily lead to higher costs.

### Means for Solving Problem

An aspect of the present invention is a reverse direction traveling detection apparatus including: a position information acquisition unit that acquires position information on a current position of a vehicle acquired by a positioning sensor, the positioning sensor measuring a position of the vehicle; a driving information acquisition unit that acquires driving information of the vehicle, the driving information including information on a detection value detected by a detector, the detection value varying in accordance with a road surface profile of a road surface on which the vehicle travels; a road map information acquisition unit that acquires road map information including information on a road lane and information on the road surface profile; and a reverse direction traveling determination unit that determines whether the vehicle travels in a reverse direction, based on the position information acquired by the position information acquisition unit, the driving information acquired by the driving information acquisition unit and the road map information acquired by the road map information acquisition unit. The road map information acquired by the road map information acquisition unit includes a first reference road surface profile defined as the road surface profile in a first lane and a second reference road surface profile defined as the road surface profile in a second lane, a normal travel direction in the first lane being a first direction, a normal travel direction in the second lane being a second direction opposite to the first direction. The reverse direction traveling determination unit acquires an actually measured road surface profile defined as the road surface profile of the road surface on which the vehicle is traveling, based on the information on the detection value acquired by the driving information acquisition unit, and determines a travel direction of the vehicle based on the position information acquired by the position information acquisition unit, further determines whether a coincidence degree between the actually measured road surface profile and the first reference road surface profile corresponding to the current position of the vehicle acquired by the position information acquisition unit is equal to or greater than a predetermined value when it is determined that the travel direction of the vehicle is the first direction, and determines whether the vehicle travels in the reverse direction based on the actually measured road surface profile and the second reference road surface profile corresponding to the current position of the vehicle acquired by the position information acquisition unit when the coincidence degree between the actually measured road surface profile and the first reference road surface profile is less than the predetermined value.

Another aspect of the present invention is a reverse direction traveling detection method including causing a computer to execute steps of: acquiring position information on a current position of a vehicle acquired by a positioning sensor measuring a position of the vehicle; acquiring driving information of the vehicle, the driving information including information on a detection value detected by a detector, the detection value varying in accordance with a road surface profile of a road surface on which the vehicle travels; acquiring road map information including information on a road lane and information on the road surface profile; and determining whether the vehicle travels in a reverse direction, based on the position information acquired, the driving information acquired and the road map information acquired. The road map information acquired includes a first reference road surface profile defined as the road surface profile in a first lane and a second reference road surface profile defined as the road surface profile in a second lane, a normal travel direction in the first lane being a first direction, a normal travel direction in the second lane being a second direction opposite to the first direction. The determining includes: acquiring an actually measured road surface profile defined as the road surface profile of the road surface on which the vehicle is traveling, based on the information on the detection value acquired, and determining a travel direction of the vehicle based on the position information acquired; further determining whether a coincidence degree between the actually measured road surface profile and the first reference road surface profile corresponding to the current position of the vehicle acquired is equal to or greater than a predetermined value when it is determined that the travel direction of the vehicle is the first direction; and determining whether the vehicle travels in the reverse direction based on the actually measured road surface profile and the second reference road surface profile corresponding to the current position of the vehicle acquired when the coincidence degree between the actually measured road surface profile and the first reference road surface profile is less than the predetermined value.

### Effect of the Invention

According to the present invention, it is possible to detect a traveling in a reverse direction of a vehicle with an inexpensive configuration.

### BRIEF DESCRIPTION OF THE DRAWINGS

FIG. 1 is a diagram illustrating an example of a road to which a reverse direction traveling detection apparatus according to an embodiment of the present invention is applied;

FIG. 2 is a diagram illustrating an overall configuration of a reverse direction traveling detection system including the reverse direction traveling detection apparatus according to the embodiment of the present invention;

FIG. 3A is a diagram illustrating an example of a road surface profile acquired by a server device in FIG. 2;

FIG. 3B is a diagram illustrating an example of a road surface profile converted for a determination of a traveling in reverse direction;

FIG. 4 is a block diagram illustrating a functional configuration of the reverse direction traveling detection apparatus according to the embodiment of the present invention;

FIG. 5 is a flowchart illustrating an example of processing executed by a controller in FIG. 4; and

FIG. 6 is a diagram for explaining an example of an operation of the reverse direction traveling detection apparatus according to the embodiment of the present invention.

### DESCRIPTION OF EMBODIMENT

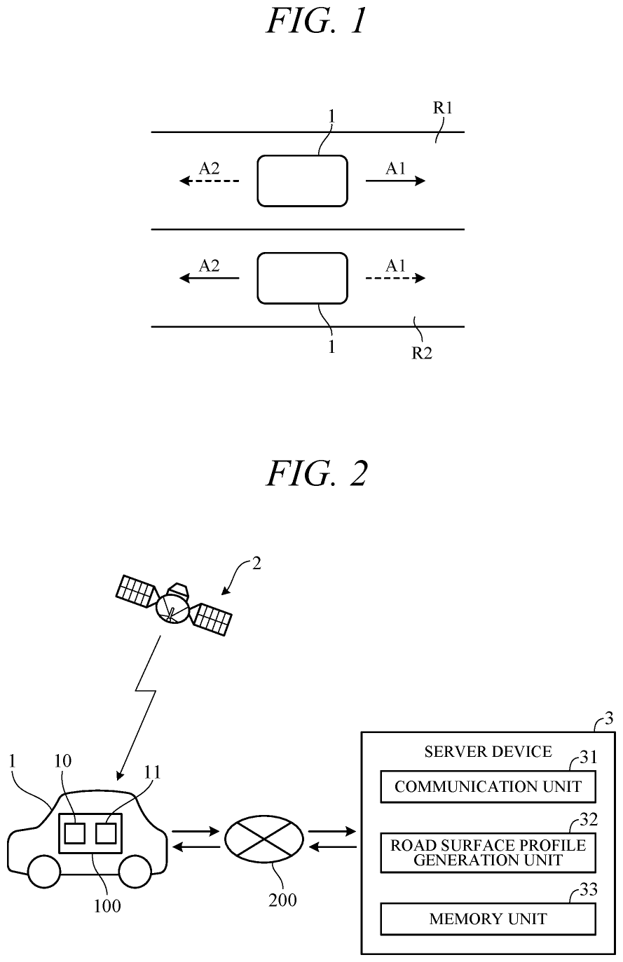

Now, an embodiment of the present invention will be described with reference to FIGS. 1 to 6. The reverse direction traveling detection apparatus according to an embodiment of the present invention is an apparatus that detects a traveling in reverse direction, which travels on the road in the opposite direction to the normal travel direction, due to a driver's misunderstanding, inattention, or other causes. For example, as illustrated in FIG. 1, which is a plan view of the road, the direction indicated by an arrow A1 (solid line) in a first lane R1 and the direction indicated by an arrow A2 (solid line) in a second lane R2 are predefined normal travel directions (normal directions), and the direction indicated by arrows A2 (dotted line) in the first lane R1 and the direction indicated by an arrow A1 (dotted line) in the second lane R2 are travel directions when a vehicle 1 travels in reverse direction (reversely traveling direction).

FIG. 2 illustrates the overall configuration of a reverse direction traveling detection system including the reverse direction traveling detection apparatus according to the present embodiment. As illustrated in FIG. 2, the reverse direction traveling detection system includes an in-vehicle device 100 mounted on the vehicle 1 and a server device 3 that can communicate with the in-vehicle device 100 via a network 200.

The in-vehicle device 100 includes a positioning sensor 10 that receives signals for positioning transmitted from a positioning satellite 2 and a communication unit 11 that communicates with the server device 3 via the network 200. The positioning satellite 2 is an artificial satellite such as a GPS satellite or quasi-zenith satellite. The current position (latitude, longitude, and altitude) of the vehicle 1 can be calculated using positioning information from the positioning satellite 2 received by the positioning sensor 10. The calculated current position is not always highly accurate, and it may be difficult to accurately identify the traveling lane, that is, to detect a traveling in reverse direction, using only signals from the positioning sensor 10.

The network 200 includes not only public wireless communication networks, such as Internet networks and cellular phone networks, but also closed communication networks provided for each predetermined management area, such as wireless LAN, Wi-Fi (registered trademark), and Bluetooth (registered trademark). The server device 3 is configured as, for example, a single server or a distributed server including separate servers for each function. The server device 3 may also be configured as a distributed virtual server created in a cloud environment called a cloud server.

The server device 3 is configured to include a processing device including a CPU, a ROM, a RAM, and other peripheral circuits, and its functional configuration includes a communication unit 31, a road surface profile generation unit 32, and a memory unit 33.

The communication unit 31 is configured to be capable of wireless communication with the in-vehicle device 100 via the network 200, and acquires the position information of the vehicle 1 and the driving information of the vehicle 1 via the communication unit 11 of the vehicle 1. The position information is information indicating the current position of the vehicle 1 calculated by the signals received by the positioning sensor 10 of the vehicle 1. The driving information is information indicating the driving state of the vehicle 1 acquired by various sensors mounted on the vehicle 1. The driving information includes information on the detected values by the acceleration sensor (lateral acceleration sensor) that detects the acceleration (lateral acceleration) of the vehicle 1 in the left-right direction. The communication unit 31 constantly acquires position information and driving information not only for the vehicle 1 (subject vehicle), which is subject to a detection of traveling in reverse direction but also for a plurality of vehicles 1 other than the subject vehicle.

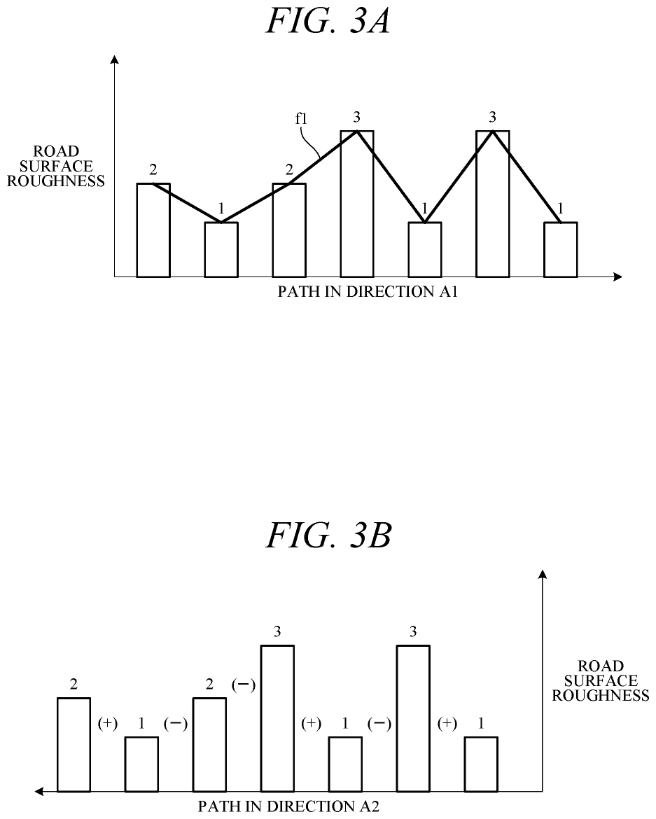

The road surface profile generation unit 32 generates a road surface profile indicating the road surface properties based on the position information and driving information of a plurality of vehicles 1 other than the subject vehicle acquired via the communication unit 31. Characteristic f1 in FIG. 3A indicates an example of a road surface profile. The horizontal axis in the figure is the position of normal travel direction of the vehicle 1, that is, the path in the direction A1 in FIG. 1, and the vertical axis is the amount of unevenness (depth or height) of the road surface, that is, the road surface roughness.

In general, the greater the amount of unevenness of the road surface, the greater the lateral acceleration of the vehicle 1. Therefore, there is a predetermined correlation between road surface properties and lateral acceleration. The road surface profile generation unit 32 calculates the amount of unevenness of the road surface corresponding to the vehicle position on the road from the lateral acceleration using this predetermined correlation and generates a road surface profile in the travel direction of the vehicle 1 as illustrated in FIG. 3A.

Furthermore, the road surface profile generation unit 32 converts the characteristic f1 of the road surface profile into digital values (integer values) represented by integers, such as 1, 2 . . . etc., at every predetermined distance as illustrated in FIG. 3A. That is, the larger the amount of unevenness, the larger the converted digital value. In this way, the road surface profile is represented by a string of digital values. For example, in the example in FIG. 3A, the road surface profile is represented by a string of digital values “2→1→2→3→1→3→1”.

When different vehicles 1 travel in the same lane, the road surface profiles detected by the lateral acceleration sensors of the vehicles 1 may differ due to different tire positions on the road surface. In this case, the road surface profile generation unit 32 generates a representative road surface profile for each road surface by averaging the respective road surface profiles detected by, for example, the lateral acceleration sensors of the vehicles 1. Also in this case, the road surface profile is represented by a string of digital values.

The road surface profile generation unit 32 can also generate a road surface profile from data acquired by driving a special vehicle dedicated to measuring road surface properties. For example, a road surface profile can be generated without using the lateral acceleration sensor by driving a special vehicle equipped with a laser profiler and acquiring the measurement data along with the position data of the special vehicle.

The memory unit 33 stores the predetermined correlation between the road surface properties and lateral acceleration used when the road surface profile is generated by the road surface profile generation unit 32, and stores road map information. Road map information includes road location information, road shape (curvature or the like) information, road grade information, position information on intersections and branch points, number of lanes, lane widths, and position information for each lane. The position information for each lane includes information on the center position of the lane and the boundaries of the lane position. In addition, the road map information includes information on the road surface profile at each location on the road generated by the road surface profile generation unit 32, that is, information on the road surface profile defined by a string of digital values.

The road surface profile information among the road map information pieces stored in the memory unit 33 is updated each time a road surface profile is generated by the road surface profile generation unit 32. The other road map information are updated at predetermined cycles or at arbitrary times. In the present embodiment, when detecting travel in reverse direction of the vehicle 1, it is assumed that the road surface profile (reference road surface profile) at the travel position of the vehicle 1 has already stored in the memory unit 33.

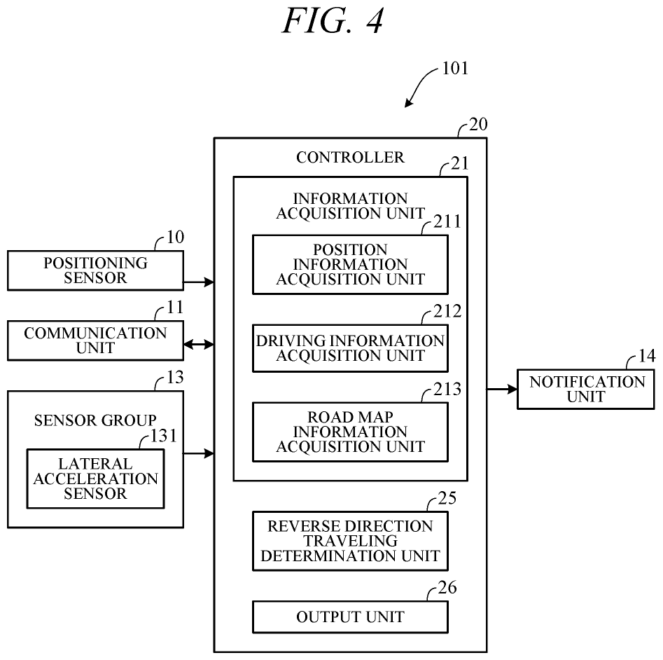

FIG. 4 is a block diagram illustrating a functional configuration of a reverse direction traveling detection apparatus 101 according to the present embodiment. The reverse direction traveling detection apparatus 101 is included in the in-vehicle device 100 in FIG. 1. As illustrated in FIG. 4, the reverse direction traveling detection apparatus 101 includes the positioning sensor 10, the communication unit 11, a sensor group 13, a notification unit 14, and a controller 20. The positioning sensor 10, the communication unit 11, the sensor group 13, and the notification unit 14 are each communicatively connected to the controller 20.

The sensor group 13 is a generic term for a plurality of sensors that detect the driving state of the vehicle 1. The sensor group 13 includes a lateral acceleration sensor 131 that detects the acceleration of the vehicle 1 in the left-right direction. The notification unit 14 is a device for notifying the driver of the vehicle 1 of predetermined information, and includes a monitor for displaying images and a speaker for outputting sound.

The controller 20 is an electronic control unit including a computer with a processing unit such as a CPU, a memory unit such as a ROM and a RAM, and other peripheral circuits. The processing unit of the controller 20 has, as its functional configuration, an information acquisition unit 21, a reverse direction traveling determination unit 25, and an output unit 26. The information acquisition unit 21 has a position information acquisition unit 211, a driving information acquisition unit 212, and a road map information acquisition unit 213. Similar to the memory unit 33 of the server device 3, the memory unit of the controller 20 stores predetermined correlations between road surface properties and lateral acceleration used when road surface profiles are generated, and threshold values for making various determinations.

The position information acquisition unit 211 acquires the current position information of the vehicle 1 detected by the positioning sensor 10. The driving information acquisition unit 212 acquires driving information of the vehicle 1, including various detected values detected by the sensor group 13. The road map information acquisition unit 213 acquires road map information from the server device 3 via the communication unit 11. More specifically, the road map information acquisition unit 213 acquires road map information that includes lane information of the road at the current position of the vehicle 1 detected by the positioning sensor 10 and road surface profile information of each lane.

The reverse direction traveling determination unit 25 determines whether the vehicle 1 travels in reverse direction based on the current position information of the vehicle 1 acquired by the position information acquisition unit 211, the driving information of the vehicle 1 acquired by the driving information acquisition unit 212, and the road map information of the road on which the vehicle 1 travels acquired by the road map information acquisition unit 213. That is, it determines whether the vehicle 1 travels in the lane R1 in FIG. 1 along the direction of the arrow A2, and the lane R2 in FIG. 1 along the direction of the arrow A1.

In this case, the amount of unevenness of the road surface is first calculated from the lateral acceleration detected by the lateral acceleration sensor 131 using the correlation between the road surface properties and the lateral acceleration stored in advance. When lateral acceleration is exerted on the vehicle 1 while turning of the vehicle, etc., the amount of unevenness of the road surface is calculated from the detected values of the lateral acceleration sensor 131, taking into account the effect of the lateral acceleration, that is, compensating for the effect of the lateral acceleration. Then, a road surface profile representing the change in the amount of unevenness of the road surface along the travel direction of the vehicle 1, that is, the actually measured road surface profile, is generated. The generated actually measured road surface profile is then converted to digital values (integer values) at every predetermined distance as illustrated in FIG. 3A. In this way, the actually measured road surface profile is represented by a string of digital values, that is, a string of measured integer values.

Furthermore, the reverse direction traveling determination unit 25 determines the travel direction of the vehicle 1 based on the signals from the positioning sensor 10. That is, it determines whether the vehicle 1 travels in the direction of the arrow A1 (referred to as a first direction) or the arrow A2 (referred to as a second direction) in FIG. 1 by detecting changes in the position of the vehicle 1 over time. When it is determined that the travel direction of the vehicle 1 is the first direction A1, a coincidence degree, which indicates the similarity between the road surface profile in the first lane R1 (referred to as a first reference road surface profile) in which the first direction A1 is the normal direction, among the road surface profile corresponding to the current position of the vehicle 1 included in the road map information, and the actually measured road surface profile, is calculated. When the coincidence degree is equal to or greater than a predetermined value, it is determined that the vehicle 1 does not travel in reverse direction, that is, the vehicle 1 travels in the first lane R1. The coincidence degree is calculated by comparing digital values that indicate the road surface profile with each other. For example, the magnitudes of the digital values are compared with each other and the coincidence degree is calculated according to the size of the difference or according to the rate of change of the digital values.

On the other hand, if the coincidence degree is less than a predetermined value, there is a possibility that the vehicle 1 travels in reverse direction. In this case, the reverse direction traveling determination unit 25 determines that the vehicle 1 travels in reverse direction, based on the road surface profile in the second lane R2 (referred to as a second reference road surface profile) in which the second direction A2 is the normal direction opposite to the travel direction of the vehicle 1 (the first direction A1), among the road surface profile corresponding to the current position of the vehicle 1 included in the road map information, and the actually measured road surface profile.

More specifically, first, the order of the string of digital values in the second reference road surface profile is reversed, and the second reference road surface profile is converted into a road surface profile for determination of the traveling in reverse direction. For example, when the string of digital values in the second reference road surface profile is “2→1→2→3→1→3→1” (FIG. 3A), the converted road surface profile along the path in the second direction A2 is “1→3→1→3→2→1→2” as illustrated in FIG. 3B. Next, focusing on the change in the digital values of the road surface profile after this conversion, the change in the digital values is acquired by setting plus “+” when the digital value increases, minus “−” when the digital value decreases, and “0” or “+” when the digital value does not change. In the example in FIG. 3B, the change in the digital values is “(+)→(−)→(+)→(−)→(−)→(+)”.

The reverse direction traveling determination unit 25 compares the change in the digital values acquired in this way with the change in the digital values acquired from the actually measured road surface profile, and calculates the coincidence degree between the road surface profiles. Then, it determines that the vehicle 1 is traveling in reverse direction when the coincidence degree is equal to or greater than a predetermined value. Thus, by determining the traveling in reverse direction based not on the magnitude of the digital values but on the change (increase or decrease) of the digital values, that is, the continuity of unevenness of the road surface, it is possible to easily and accurately determine whether the vehicle travels in reverse direction or not. That is, the magnitude of the digital values is prone to variation (error), but the tendency of the digital values to increase or decrease is less prone to variation. For example, when the magnitude of the digital values is used as the reference, the peak value of the unevenness of the road surface must be detected with high accuracy. However, when the change in the digital values is used as the reference, it is not necessary to detect the peak value with high accuracy, and it is sufficient to detect a trend of unevenness. Therefore, the traveling in reverse direction can be easily and accurately determined based on the change in the digital values.

When the reverse direction traveling determination unit 25 determines that the vehicle 1 travels in reverse direction, the output unit 26 outputs an alarm signal to the notification unit 14. This causes an alarm message to be displayed on the monitor of the vehicle 1 or an alarm sound to be output from the speaker. As a result, the driver can recognize that the vehicle 1 travels in reverse direction. The output unit 26 may transmit an alarm signal to the server device 3 via the communication unit 11, and may cause the server device 3 to output an alarm signal to other vehicles 1 around the subject vehicle 1 or to a display portion installed facing the road within a predetermined distance from the subject vehicle 1. This can alert drivers of other vehicles 1.

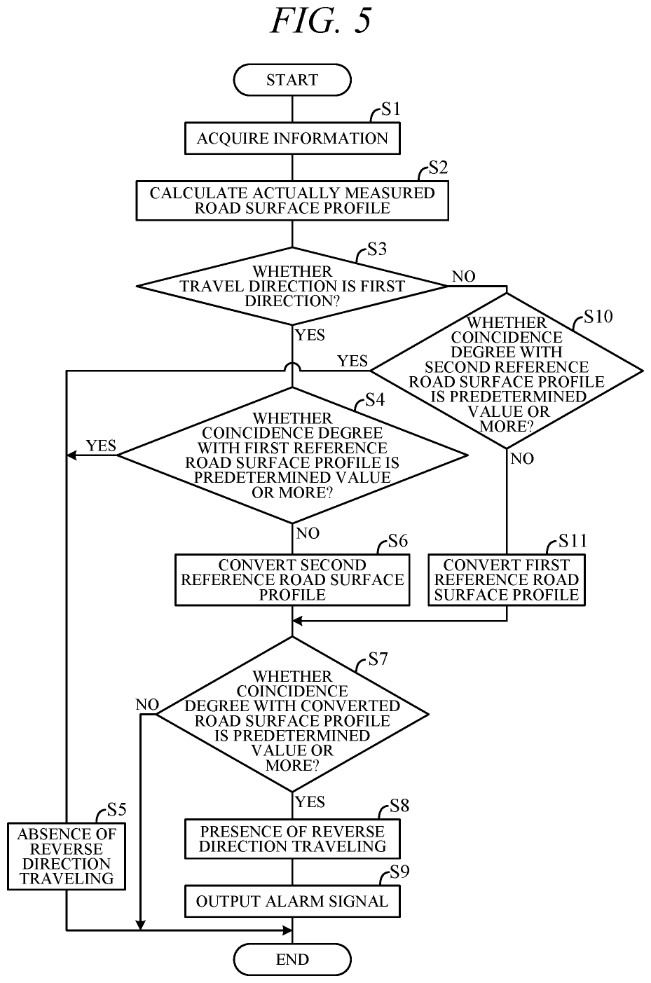

FIG. 5 is a flowchart illustrating one example of processing executed by the controller 20 in FIG. 4 in accordance with a predetermined program. The processing illustrated in this flowchart is executed during traveling of the vehicle, and is repeated in a predetermined cycle. First, in step S1, the current position information of the vehicle 1 detected by the positioning sensor 10, the driving information of the vehicle 1 acquired by the sensor group 13, and the road map information of the road being traveled obtained via the communication unit 11 are acquired.

Next, in step S2, the actually measured road surface profile is calculated based on the detected values of the lateral acceleration sensor 131. The calculated actually measured road surface profile is represented by a string of digital values (measured integer values), as illustrated in FIG. 3A. Next, in step S3, it is determined whether the moving direction of the vehicle 1 is the first direction A1 in FIG. 1 based on the signals from the positioning sensor 10.

If YES in step S3, the processing proceeds to step S4 to determine whether the coincidence degree between the actually measured road surface profile calculated in step S2 and the first reference road surface profile corresponding to the current position of the vehicle 1, that is, the first reference road surface profile for the first lane R1 included in the road map information, is equal to or greater than a predetermined value. Specifically, the coincidence degree is calculated by comparing the digital values representing the actually measured road surface profile with the digital values representing the first reference road surface profile. The predetermined value is a first predetermined value, and the first predetermined value is set to a value in the range of, for example, from 50% to 80%. If YES in step S4, the processing proceeds to step S5. In step S5, it is determined that the vehicle 1 travels in the first direction A1 along the first lane R1, and the processing ends with a determination that the vehicle 1 does not travel in reverse direction.

If NO in step S4, the processing proceeds to step S6 to convert the digital values representing the second reference road surface profile corresponding to the current position of the vehicle 1, that is, the second reference road surface profile of the second lane R2 included in the road map information, into values for a determination of traveling in reverse direction. More specifically, the string of digital values in the second reference road surface profile are reversed, and a converted road surface profile is generated, which is a string of signs representing the increase or decrease of digital values in terms of plus and minus signs.

Next, in step S7, it is determined whether the coincidence degree between the actually measured road surface profile calculated in step S2 and the road surface profile generated in step S6 is equal to or greater than a predetermined value. That is, it determines whether the change in the digital values representing the actually measured road surface profile is consistent with the change in the digital values in step S6 to a predetermined degree or greater. The predetermined value is a second predetermined value, and the second predetermined value is set to a value in the range of, for example, from 50% to 80%. The second predetermined value may be set to a value greater than the first predetermined value in step S4, or the second predetermined value may be set to a value equal to or less than the first predetermined value.

If YES in step S7, the processing proceeds to step S8, and if NO, the processing ends. In step S8, it is determined that the vehicle 1 travels in the first direction A1 along the second lane R2. That is, it is determined that the vehicle 1 travels in reverse direction. Next, in step S9, an alarm signal is output to the notification unit 14 to generate an alarm from the monitor and speaker of the vehicle 1, and the processing ends.

On the other hand, if NO in step S3, that is, the moving direction of the vehicle 1 is determined to be the second direction A2 in FIG. 1, the processing proceeds to step S10. In step S10, it is determined whether the coincidence degree between the actually measured road surface profile calculated in step S2 and the second reference road surface profile corresponding to the current position of the vehicle 1, that is, the second reference road surface profile for the second lane R2 included in the road map information, is equal to or greater than a predetermined value. Specifically, as in step S4, the coincidence degree is calculated by comparing the digital values representing the actually measured road surface profile with the digital values representing the second reference road surface profile. The predetermined value is equal to the first predetermined value in step S4.

If YES in step S10, the processing proceeds to step S5, and if NO, the processing proceeds to step S11. In step S11, the digital values representing the first reference road surface profile corresponding to the current position of the vehicle 1, that is, the first reference road surface profile of the first lane R1 included in the road map information, are converted into values for a determination of traveling in reverse direction. More specifically, the string of digital values in the first reference road surface profile are reversed, and a converted road surface profile is generated, which is a string of signs representing the increase or decrease of digital values in terms of plus and minus signs. Next, the processing proceeds to step S7.

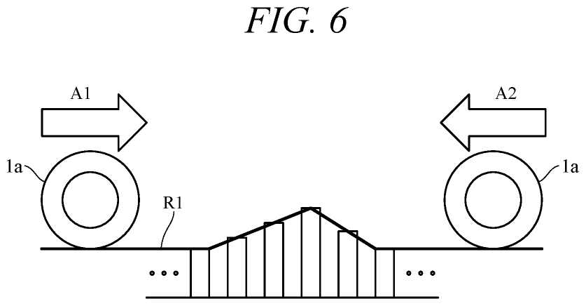

The operation of the reverse direction traveling detection apparatus 101 according to the present embodiment is summarized as follows. FIG. 6 schematically illustrates the state of the vehicle 1 traveling along the first lane R1 by a tire 1a. The road surface profile is represented by the digital values of the first reference road surface profile. As illustrated in FIG. 6, when the vehicle 1 travels in the first direction A1, the actually measured road surface profile is compared with the first reference road surface profile (step S4). When the coincidence degree is equal to or greater than a predetermined value, it is determined that traveling in reverse direction is not occurring (step S5).

On the other hand, when the vehicle 1 travels in the second direction A2, it is determined whether the coincidence degree between the actually measured road surface profile and the second reference road surface profile is equal to or greater than a predetermined value (step S10). In this case, since the coincidence degree is not equal to or greater than the predetermined value, the change in the first reference road surface profile after the conversion in which the string of digital values in the first reference road surface profile is reversed is compared with the change in the actually measured road surface profile (step S11→step S7). When the coincidence degree is equal to or greater than the predetermined value, it is determined that traveling in reverse direction is occurring, and an alarm signal is output (step S8 and step S9).

According to the present embodiment, the following operations and effects are achievable.

(1) A reverse direction traveling detection apparatus 101 includes: a position information acquisition unit 211 that acquires position information of the current position of a vehicle 1 acquired by a positioning sensor 10 that measures a position of the vehicle 1; a driving information acquisition unit 212 that acquires driving information of the vehicle 1, including information on sensor values of a lateral acceleration sensor 131 that vary according to the road surface profile of the road surface on which the vehicle 1 travels; a road map information acquisition unit 213 that acquires road map information including lane information and road surface profile information of the road; and a reverse direction traveling determination unit 25 that determines whether the vehicle 1 travels in reverse direction based on position information acquired by the position information acquisition unit 211, driving information acquired by the driving information acquisition unit 212, and road map information acquired by the road map information acquisition unit 213 (FIG. 4). The road map information acquired by the road map information acquisition unit 213 includes a first reference road surface profile, which is the road surface profile in the first lane R1 with the travel direction defined as the first direction A1, and a second reference road surface profile, which is the road surface profile in the second lane R2 with the travel direction defined as the second direction A2 opposite the first direction A1 (FIG. 1). The reverse direction traveling determination unit 25 acquires an actually measured road surface profile on the road surface on which the vehicle 1 is traveling based on the lateral acceleration information acquired by the driving information acquisition unit 212, and determines the travel direction of the vehicle 1 based on the position information acquired by the position information acquisition unit 211. If the reverse direction traveling determination unit 25 determines that the travel direction of the vehicle 1 is the first direction A1, it further determines whether the coincidence degree between the actually measured road surface profile and the first reference road surface profile corresponding to the current position of the vehicle 1 acquired by the position information acquisition unit 211 is equal to or greater than a first predetermined value. If the reverse direction traveling determination unit 25 determines that the coincidence degree between the actually measured road surface profile and the first reference road surface profile is less than the first predetermined value, it determines that the vehicle 1 travels in reverse direction based on the actually measured road surface profile and the second reference road surface profile corresponding to the current position of the vehicle 1 acquired by the position information acquisition unit 211 (FIG. 5).

This configuration allows the vehicle itself to determine whether or not traveling in reverse direction is occurring. This eliminates the need to install cameras for detecting a traveling in reverse direction on the road and makes it possible to detect the traveling in reverse direction of the vehicle 1 at a lower overall cost. Since the traveling in reverse direction of the vehicle 1 is detected based on the road surface profile, it is not necessary to detect lanes with high accuracy, and it is sufficient to detect the rough position of the vehicle 1. That is, it is not necessary to detect whether the lane currently being traveled is the first lane R1 or the second lane R2. This eliminates the need for the high-precision positioning sensor 10, which also makes the device inexpensive.

(2) When the reverse direction traveling determination unit 25 determines that the coincidence degree between the actually measured road surface profile and the first reference road surface profile is less than the first predetermined value, it converts the second reference road surface profile into a reference road surface profile in the wrong travel direction and determines whether the vehicle 1 travels in reverse direction based on the coincidence degree between the converted reference road surface profile and the actually measured road surface profile (FIG. 5). By determining a traveling in reverse direction based on the road surface profile in this way, the traveling in reverse direction can be determined with high accuracy. That is, the present embodiment focuses on the fact that the road surface profile differs between the normal travel direction and wrong travel direction, and determines whether or not a traveling in reverse direction is occurring based on the coincidence degree between the road surface profiles in each direction, thus allowing accurate detection of the traveling in reverse direction of the vehicle 1 at low cost.

(3) The reverse direction traveling determination unit 25 calculates the coincidence degree between the first reference road surface profile and the actually measured road surface profile based on the magnitude of road surface unevenness, and also calculates the coincidence degree between the converted reference road surface profile and the actually measured road surface profile based on the change in road surface unevenness. That is, the determination of the normal travel direction and the determination of the wrong travel direction are performed in different ways from each other. This allows for efficient and accurate detection of traveling in reverse direction of the vehicle 1.

(4) The reverse direction traveling detection apparatus 101 further includes an output unit 26 that outputs an alarm signal when the reverse direction traveling determination unit 25 determines that the vehicle 1 travels in reverse direction (FIG. 4). This allows the driver and others to be notified that the vehicle 1 travels in reverse direction.

(5) The reverse direction traveling detection apparatus 101 of the present embodiment can also be used as a reverse direction traveling detection method. The reverse direction traveling detection method includes causing a computer to execute the followings: a step of acquiring position information of the current position of the vehicle 1 acquired by the positioning sensor 10 that measures a position of the vehicle 1, driving information of the vehicle 1, including information on sensor values of the lateral acceleration sensor 131, which vary according to the road surface profile of the road surface on which the vehicle 1 is driving, and road map information including road lane information and road surface profile information (step S1); and a step of determining a traveling in reverse direction of the vehicle 1 based on the acquired position information, driving information, and road map information (FIG. 5). The acquired road map information includes a first reference road surface profile, which is the road surface profile in the first lane R1 with the travel direction defined as the first direction A1, and a second reference road surface profile, which is the road surface profile in the second lane R2 with the travel direction defined as the second direction A2 opposite the first direction A1 (FIG. 1). The step of determining of the traveling in reverse direction of the vehicle 1 acquires the actually measured road surface profile on the road surface on which the vehicle 1 is traveling based on the acquired sensor value information, and determines the travel direction of the vehicle 1 based on the acquired position information (step S3). When it is determined that the travel direction of the vehicle 1 is the first direction A1, the step of determining further determines whether the coincidence degree between the actually measured road surface profile and the first reference road surface profile corresponding to the acquired current position of the vehicle 1 is equal to or greater than a predetermined value (step S4). When it is determined that the coincidence degree between the actually measured road surface profile and the first reference road surface profile is less than the predetermined value, the step of determining determines whether the vehicle 1 travels in reverse direction based on the actually measured road surface profile and the second reference road surface profile corresponding to the acquired current position of the vehicle 1 (step S7 and step S8). This allows inexpensive configuration to detect a traveling in reverse direction of the vehicle 1.

In the above embodiment, the driving information acquisition unit 212 acquires driving information of the vehicle 1 including information on the detection values (sensor values) of the lateral acceleration sensor 131, but it may also acquire driving information including information on the detection values of other detectors that vary according to the road surface profile. For example, the driving information acquisition unit may acquire driving information including information on the detection values of sensors that detect the acceleration of the vehicle 1 in the front-rear direction (front-rear acceleration), the detection values of sensors that detect the roll angle and roll rate, and the detection values of sensors that detect the vibration of the vehicle in the vertical direction.

In the above embodiment, whether or not the vehicle 1 travels in the normal travel direction is determined based on the magnitude of the digital values (integers) representing the road surface profile, and whether or not the vehicle 1 travels in the wrong travel direction is determined based on the change in the digital values (integers) representing the road surface profile, but these determination methods are not limited to those described above. For example, whether or not the vehicle 1 travels in the normal direction may be determined based on the change in the digital values representing the road surface profile, and whether or not the vehicle 1 travels in the wrong travel direction may be determined based on the magnitude of the digital values representing the road surface profile.

In the above embodiment, the reverse direction traveling detection apparatus 101 is mounted in the vehicle 1, but part or all of the functions of the reverse direction traveling detection apparatus 101 may be provided in the server device 3.

In the above embodiment, the vehicle 1 includes the positioning sensor 10 that receives signals for positioning transmitted from the positioning satellite 2, but the positioning sensor 10 may be used for measuring the vehicle position by other methods, such as self-contained navigation. That is, a positioning sensor is not limited to one that receives signals transmitted from a positioning satellite to measure a position of the vehicle.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

1 vehicle, 2 positioning satellite, 10 positioning sensor, 11 communication unit, 14 notification unit, 20 controller, 21 information acquisition unit, 25 reverse direction traveling determination unit, 26 output unit, 101 reverse direction traveling detection apparatus, 131 lateral acceleration sensor, 211 position information acquisition unit, 212 driving information acquisition unit, 213 road map information acquisition unit, R1 first lane, R2 second lane, A1 first direction, A2 second direction

1-6. (canceled)

7. A reverse direction traveling detection apparatus, comprising:
an electronic control unit having a microprocessor and a memory connected to the microprocessor, wherein
the microprocessor is configured to perform:
acquiring position information on a current position of a vehicle;
acquiring driving information of the vehicle, the driving information including information on a detection value detected by a detector, the detection value varying in accordance with a road surface profile of a road surface on which the vehicle travels;
acquiring road map information including information on a road lane and information on the road surface profile; and
determining whether the vehicle travels in a reverse direction, based on the position information, the driving information and the road map information, wherein
the road map information includes a first reference road surface profile defined as the road surface profile in a first lane and a second reference road surface profile defined as the road surface profile in a second lane, a normal travel direction in the first lane being a first direction, a normal travel direction in the second lane being a second direction opposite to the first direction, and wherein
the microprocessor is configured to perform
the determining including:
acquiring an actually measured road surface profile defined as the road surface profile of the road surface on which the vehicle is traveling, based on the information on the detection value, and determining a travel direction of the vehicle based on the position information;
further determining whether a coincidence degree between the actually measured road surface profile and the first reference road surface profile corresponding to the current position of the vehicle is equal to or greater than a predetermined value when it is determined that the travel direction of the vehicle is the first direction; and
determining whether the vehicle travels in the reverse direction based on the actually measured road surface profile and the second reference road surface profile corresponding to the current position of the vehicle when the coincidence degree between the actually measured road surface profile and the first reference road surface profile is less than the predetermined value.

8. The reverse direction traveling detection apparatus according to claim 7, wherein
the microprocessor is configured to perform
the determining including converting the second reference road surface profile into a reference road surface profile in the reverse direction when the coincidence degree between the actually measured road surface profile and the first reference road surface profile is less than the predetermined value, and determining whether the vehicle travels in the reverse direction based on a coincidence degree between the reference road surface profile and the actually measured road surface profile.

9. The reverse direction traveling detection apparatus according to claim 8, wherein
the microprocessor is configured to perform
the determining including calculating the coincidence degree between the first reference road surface profile and the actually measured road surface profile based on a magnitude of an unevenness on the road surface, and calculating the coincidence degree between the reference road surface profile and the actually measured road surface profile based on a change of the unevenness on the road surface.

10. The reverse direction traveling detection apparatus according to claim 7, wherein
the microprocessor is configured to further perform
outputting an alarm signal when it is determined that the vehicle travels in the reverse direction.

11. The reverse direction traveling detection apparatus according to claim 7, wherein
the first reference road surface profile is represented by a string of integer values representing a degree of an unevenness on the road surface in the first lane at every a predetermined distance along the first direction,
the second reference road surface profile is represented by a string of integer values representing a degree of an unevenness on the road surface in the second lane at every the predetermined distance along the second direction, and
the microprocessor is configured to perform
the determining including converting the actually measured road surface profile into measured integer values representing the degree of the unevenness on the road surface at every the predetermined distance along the travel direction of the vehicle, and determining whether the vehicle travels in the reverse direction based on a string of the measured integer values, the string of the integer values defining the first reference road surface profile and the string of the integer values defining the second reference road surface.

12. The reverse direction traveling detection apparatus according to claim 7, further comprising
an acceleration sensor that detects an acceleration of the vehicle in a left-right direction, wherein
the acceleration sensor is included in the detector.

13. The reverse direction traveling detection apparatus according to claim 7, further comprising
a positioning sensor that measures a position of the vehicle;
the detector; and
a communication unit, wherein
the microprocessor is configured to perform
the acquiring the position information including acquiring position data from the positioning sensor, and
the acquiring the road map information including acquiring the road map information from a server device via the communication unit.

14. A reverse direction traveling detection method, comprising
acquiring position information on a current position of a vehicle;
acquiring driving information of the vehicle, the driving information including information on a detection value detected by a detector, the detection value varying in accordance with a road surface profile of a road surface on which the vehicle travels;
acquiring road map information including information on a road lane and information on the road surface profile; and
determining whether the vehicle travels in a reverse direction, based on the position information, the driving information and the road map information, wherein
the road map information includes a first reference road surface profile defined as the road surface profile in a first lane and a second reference road surface profile defined as the road surface profile in a second lane, a normal travel direction in the first lane being a first direction, a normal travel direction in the second lane being a second direction opposite to the first direction, and
the determining includes:
acquiring an actually measured road surface profile defined as the road surface profile of the road surface on which the vehicle is traveling, based on the information on the detection value, and determining a travel direction of the vehicle based on the position information;
further determining whether a coincidence degree between the actually measured road surface profile and the first reference road surface profile corresponding to the current position of the vehicle is equal to or greater than a predetermined value when it is determined that the travel direction of the vehicle is the first direction; and
determining whether the vehicle travels in the reverse direction based on the actually measured road surface profile and the second reference road surface profile corresponding to the current position of the vehicle when the coincidence degree between the actually measured road surface profile and the first reference road surface profile is less than the predetermined value.
